(19) United States
(12) Patent Application Publication
(10) Pub. No.: US 2009/0259525 A1
(43) Pub. Date: Oct. 15, 2009

(54) Internet Probability Sampling

(76) Inventor: Daniel J. Harrington, San Francisco, CA (US)

Correspondence Address: IPxLAW Group LLP, 95 South Market Street, Suite 570, San Jose, CA, 95113, US

(21) Appl. No.: 12/422,966

(22) Filed: Apr. 13, 2009

Related U.S. Application Data
(60) Provisional application No. 61/044,831, filed on Apr. 14, 2008.

(51) Int. Cl. G06Q 10/00; G06Q 30/00; G06F 17/18; G06F 17/30

(52) U.S. Cl. 705/10; 705/14; 702/181; 707/104.1

(57) ABSTRACT

The Internet Probability Sample is a method for obtaining a statistically robust probability sample of a target population of substantial interest (including, but not limited to Internet Users in the United States) by employing an Internet advertising system. The Internet Probability Sample (IPS) dramatically changes the nature of survey research because unbiased estimates with measurable sampling variance are produced in significantly less time and at a greatly reduced cost over Area Probability Sample and Random Digit Dial methods. The use of this invention benefits all parties that utilize survey information, including governments, academics, non-profit organizations, businesses, and the public at large.

### CROSS-REFERENCE TO RELATED APPLICATIONS

This application claims priority to and incorporates by reference in its entirety U.S. Provisional Application Ser. No. 61/044,831, filed on Apr. 14, 2008 and titled “Internet Probability Sample”.

### FIELD OF THE INVENTION

The present invention relates generally to the field of survey methods and more particularly to the field of such methods employing probability samples.

### DESCRIPTION OF THE RELATED ART

Sampling is the practice of choosing a fraction of a population in order to reduce the work required to investigate the whole population. There are many methods of sampling and the practice is not confined just to surveys. An accountant performing an audit may sample financial documents to see if they are correct, or a customs agent may sample shipping containers to see if they contain contraband. While many different types of sampling may be appropriate for different applications, in academic, government, and market survey research, probability-based sampling is the only standard for producing reliable, repeatable statistics about populations of interest. Currently, Internet-based surveys are a less expensive, but inferior version of their probability-based predecessors: the face-to-face survey, which uses an Area Probability Sample (APS), and the telephone survey, which uses a Random Digit Dial (RDD) sample. The cost of conducting either of these types of survey is many times that of a non-probability-based Internet survey, but they are still employed because they produce statistical estimates that are reliable.

To explain the importance of probability sampling and define some of the terminology, suppose that a researcher is interested in a estimating the average value of a characteristic in a small population, e.g., ten people, but only has the resources to observe the characteristic in three people. The researcher must decide how best to select the three people to measure. There may be several convenient ways to make the selection. If he already knows the e-mail addresses of three of the persons, he may choose those the three, or he may simply choose the first three he runs into on the street. To persons unfamiliar with sampling, this way of choosing a sample may seem as good as any other, but the researcher must prove that he or she has formed the best possible estimate of the average of the characteristic in the population given his or her resources. Using a probability sample, the researcher can supply the proof. The researcher constructs a list of the population members, e.g., the ten people, from which he will choose the sample. This list is called a sample frame. The members that appear in the sample frame are referred to as sampling units. The researcher then rolls a fair ten-sided die to obtain three unique numbers that select the sampling units for the sample. This process gives each sampling unit in the list a 0.1 probability of being selected into the sample and is one example of a probability sample. The researcher then conducts a measurement of the three units to form an estimate of the average in the population by using the formula, y̅=Σyᵢ/n. Because the sample is a probability sample, the researcher can prove that this average of the three observations is an unbiased estimate of the average in the entire population. The researcher can also calculate the variance of the estimate and use this to form confidence intervals or calculate the margin of error of the estimate. These properties of the estimate depend on controlling the probability of selecting the sample from the population. Without conducting a probability sample, the researcher lacks a mathematical basis for claiming that the estimate has either of these properties.

In a probability sample, each member of the population of interest has a known and non-zero probability of inclusion in the sample. Various practical conditions prevent a perfect probability sample of most real-world populations. However, a reliable approximation is commonly obtained by carefully observing the two requirements of a probability sample, (i) that each unit has a known probability of selection and (ii) that the probability of selecting each unit is greater than zero. Hence, the probability of selecting each unit in the population usually cannot be known exactly prior to the survey, but the unknown factors contributing to this probability of selection are measured during the survey process. Likewise, it is operationally impossible to ensure that each member of the US population has a non-zero probability of selection, but researchers can avoid this obstacle by defining their population carefully and minimizing non-coverage (units with zero probability of selection) in the defined population.

Currently, many surveys are currently conducted on the Internet, but none of these surveys is based on a probability sample. The present invention describes a method of building probability-based samples using the Internet.

### BRIEF SUMMARY OF THE INVENTION

Referring to FIG. 2, the method and system of the Internet Probability Sample (IPS) uses the interaction of Internet users with large centralized Internet advertising systems to create a sampling frame with reasonably complete coverage of a population of interest, such as the Internet-using population of the United States. The IPS method then specifies how to draw a probability-based sample from this frame, where each unit has a measurable probability of selection. The IPS method thus fulfills the requirements of a probability-based sample. This allows a researcher to create statistics, about the population of interest, that are unbiased and have known sampling error.

The IPS method first describes the creation of an Internet-based sampling frame, in step 202, where each element has measurable probability of selection from the population of interest. The method achieves this by the use of special Internet cookies to measure a population member's interaction with the frame. In step 204, the method creates a probability-based sample from this frame and defines necessary characteristics that distinguish this sample from common, Internet-based convenience samples. After defining a sample, the method uses the Internet advertising system to contact, in step 206, selected population members in order to respond to an online survey. The method then constructs, in step 208, appropriate survey weights for IPS samples and uses the survey results to produce statistical estimates, in step 210, of population parameters.

One embodiment of the invention is a method for performing an on-line survey of a target population. The method includes the steps of (i) constructing a sample frame, (ii) performing a randomized selection process on the sample frame, (iii) sending invitations to complete and on-line survey to selected candidates, (iv) receiving a completed survey from responding candidates, (v) computing a probability of selection of a responding candidate, (vi) constructing survey weights, and (vii) calculating statistics using the survey weights. The step of constructing a sample frame is based on the interactions of a plurality of browsers with an Internet domain, where the sample frame includes one or more databases of a number of IPS cookies, and where each IPS cookie is a selectable unit in the frame. The step of performing a randomized selection process on the sample frame creates a sample of selected units from the sample frame, where each unit has a known and non-zero probability of inclusion in any sample taken from the sample frame, and each selected unit is a candidate for the on-line survey, and where the sample has a number of selected units that fit a response criteria. The step of sending invitations includes sending one or more invitations to complete the on-line survey to the selected candidates. In the step of receiving a completed survey from a number of responding candidates, the number of respondents may be less than or equal to the number of selected candidates. In the step of constructing survey weights, the survey weights are based on the selection probability of each respondent. The step of calculating one or more survey statistics uses the data from the respondents and the survey weights.

### BRIEF DESCRIPTION OF THE DRAWINGS

These and other features, aspects and advantages of the present invention will become better understood with regard to the following description, appended claims, and accompanying drawings where:

FIG. 1A provides a system setting which the present invention operates;

FIG. 1B shows the relationship between a respondent and an Internet cookie;

FIG. 2 shows a flow chart of the major steps in accordance with the present invention;

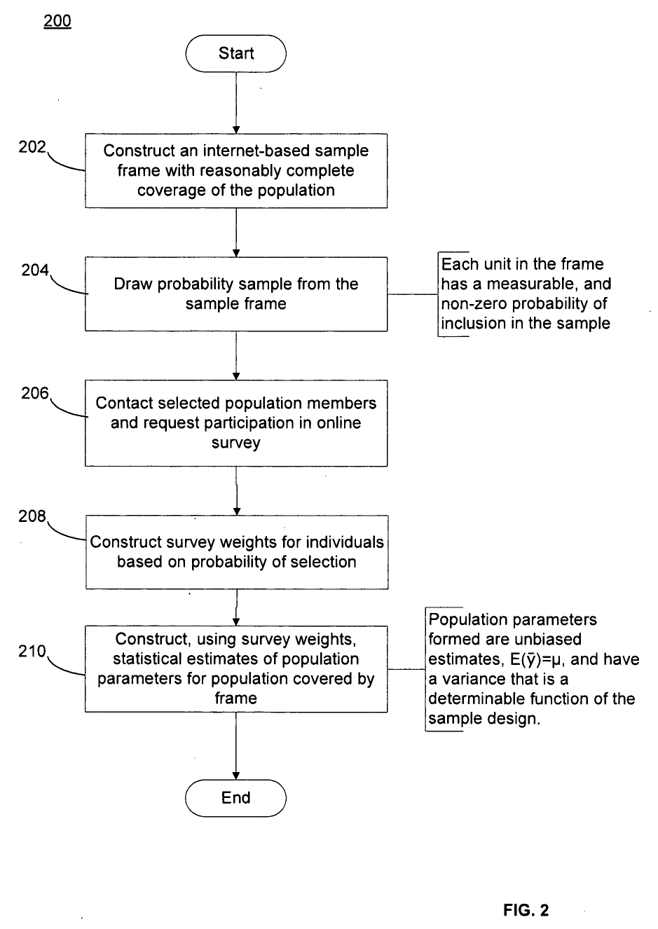

FIG. 3 shows a flow chart for disseminating an IPS cookie to computer browsers;

FIG. 4 shows a diagram of the creation of a sample frame in accordance with the present invention;

FIG. 5 shows a flow chart of the steps for taking a sample from the sampling frame in accordance with the present invention; and

FIG. 6 shows a flow chart of the steps for carrying out a survey of those population members who are in the sample, including computing the statistics of interest to the entity requesting the survey.

### DETAILED DESCRIPTION OF THE INVENTION

### IPS Internet Cookie

In one embodiment, the sampling unit for the IPS method is the IPS cookie. The vehicle hereafter referred to as the IPS cookie can be a single Internet cookie created specifically for an IPS, but it can also be a collection of existing cookies, a method of storing and utilizing Internet server information and databases, or any combination of these. Existing Internet cookies or Internet advertising systems may already perform some functions of the IPS cookie. However, we assume that we create the IPS cookie entirely from scratch.

The IPS cookie, in combination with the Internet advertising system's servers, preferably performs the following functions:
Store the date and time of the creation of the cookie
Possess a unique identifier
Set the “expires=command” to a date beyond the end of the survey field period
Have the ability to be selected to participate in a survey and indicate whether or not it has been selected
Cause the Internet advertising system server to display a survey invitation to the user's Web browser
Track the status of the cookie with respect to the survey and record if the survey has been completed
Track the number of survey invitations that have been displayed to the cookie
If necessary, store the number of sampling units associated with the Internet advertising system since it was created

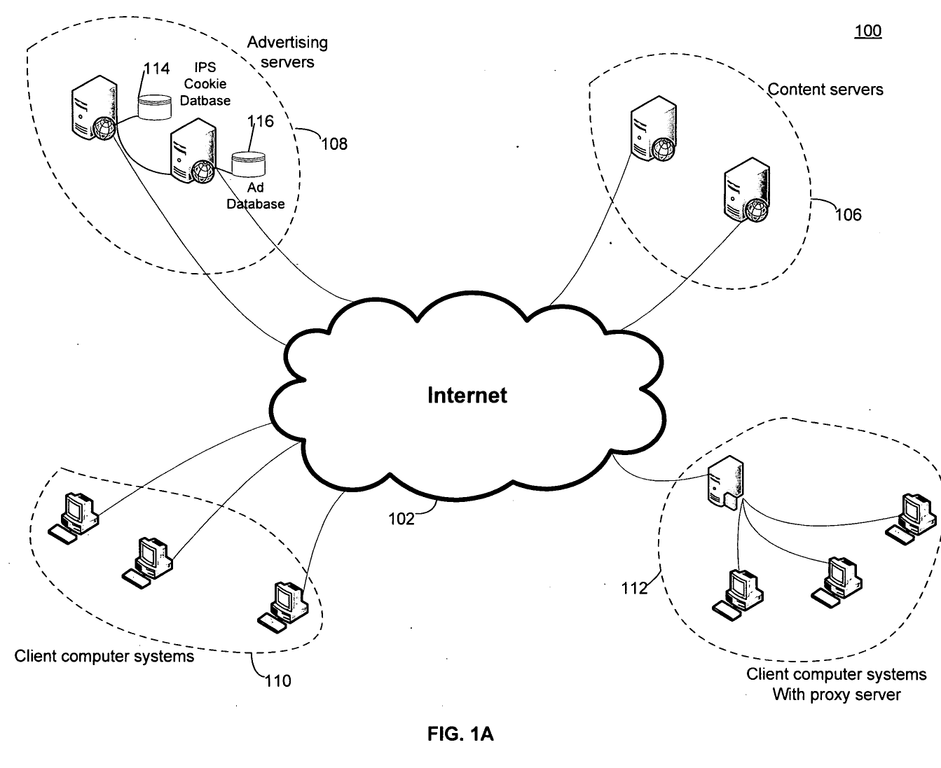

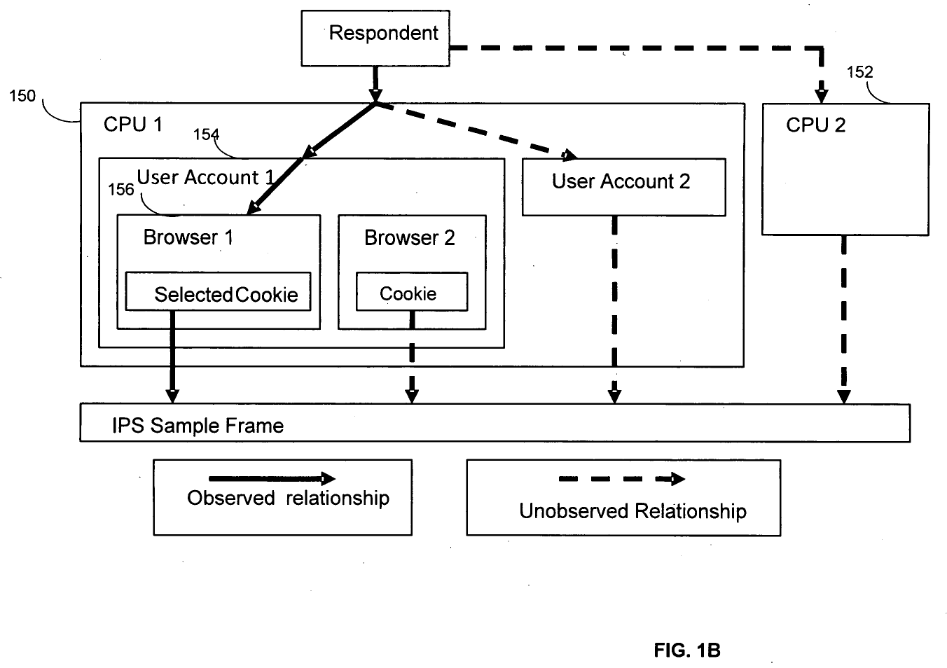

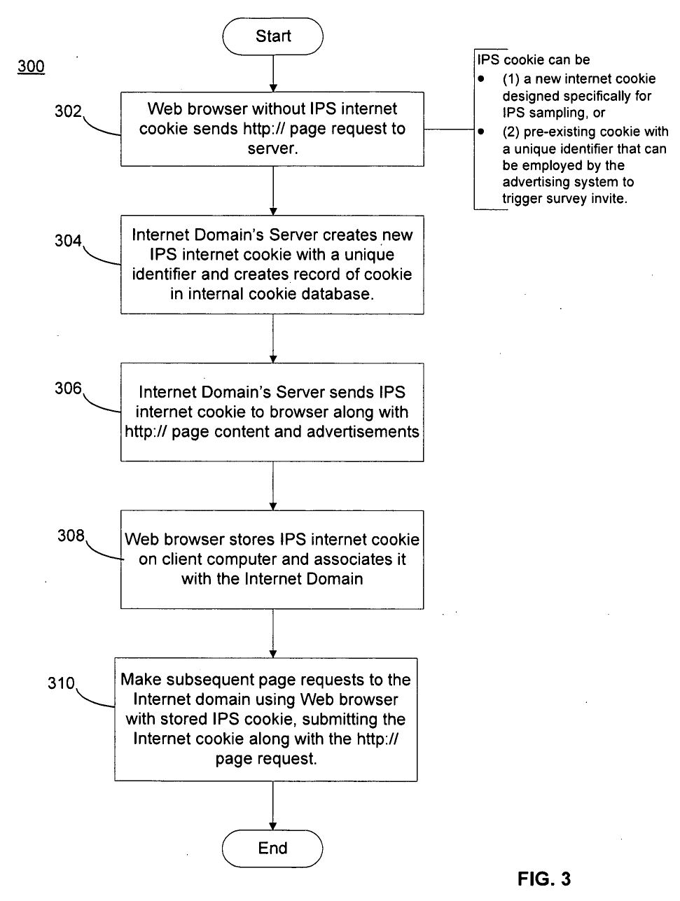

Referring to FIG. 3, a Web browser without an IPS Internet cookie sends a page request to the advertising system's server, ver 108, in FIG. 1. The Internet Domain's server creates a new IPS internal cookie with a unique identifier and creates a record of the cookie in an internal cookie database 114 in FIG. 1. As is typical for Internet cookies, the Internet advertising system's server, 108 in FIG. 1, sends, in step 306, the IPS cookie to each browser 110, 112, in FIG. 1, that visits the domain, using the HTTP command SETCOOKIE. The IPS Internet cookie is stored by the Web browser on the client computer and is associated with the Internet Domain. Upon each visit by a browser with an IPS cookie to a page (from a content server, 106 in FIG. 1) displaying advertisements from the Internet advertising system's, 108 in FIG. 1, domain, the browser 110, 112, sends, in step 310, the IPS cookie to the advertising system's servers 108. This interaction allows the Internet advertising systems' servers, 106 and ver 108, to deliver specific content to the client Web-browsers, and in the IPS method, this functionality is used to deliver survey invitations to potential respondents selected through probability-based sampling methods.

### Sampling Frame

In the preferred embodiment, the IPS sampling frame is the list of all IPS Internet cookies in the advertising system domain's databases. Every IPS Internet cookie that is delivered by the domain is a potentially selectable sampling unit, although in practice the IPS sample frame may be restricted to IPS cookies that meet certain criteria defined by the researcher. The sample frame should also include additional entries that represent new Internet cookies that are expected to be created during the sample period. In this way first time, visitors to the domain and users that have deleted their cookies since the last visit to the Internet domain have a positive probability of selection into the IPS sample.

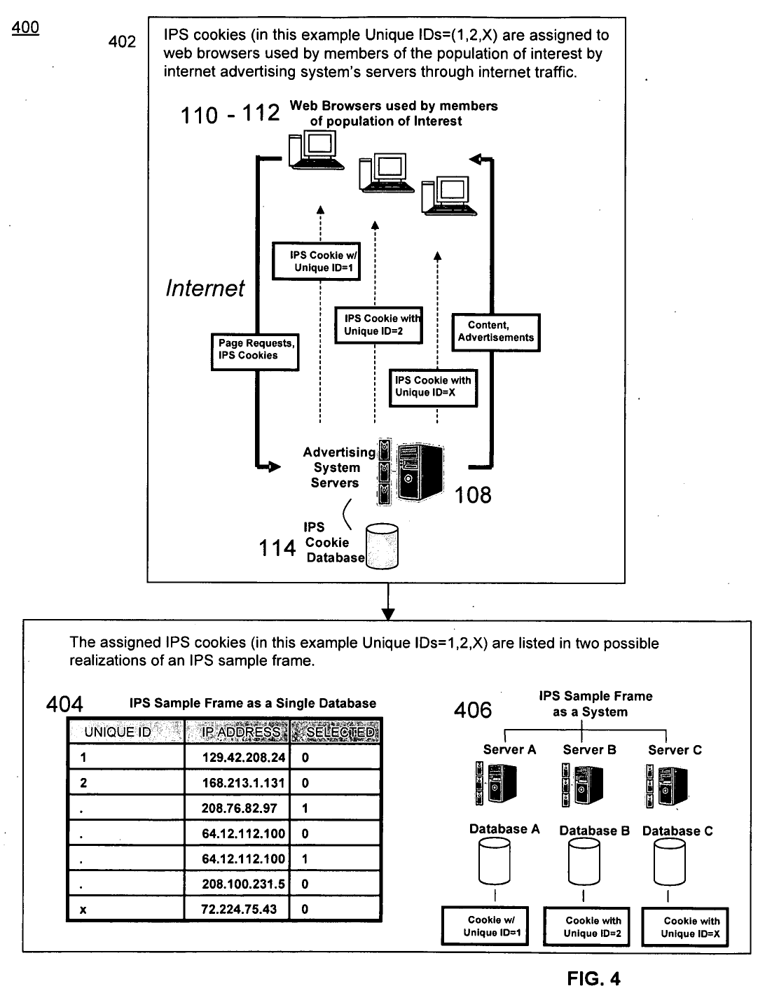

Referring to FIG. 4, the sample frame, is based on IPS cookies are assigned by the advertising system's servers to users' Web browsers used by members of the population of interest. Step 402 shows an example of this process where the IPS cookies with the Unique IDs=1,2, . . . X are assigned to Web browsers used by members of the population of interest. These IPS cookies are then listed in the examples of the IPS sample frame that consists of a single database of the cookies, as in shown in step 404, or a system of databases that can identify and select individual cookies, as shown in step 406. Functionally, the IPS sample frame must be able to select each sampling unit therein with a measurable and non-zero probability. This function is the critical objective of the sample frame and no actual physical sample frame need be created if this function can be rigorously performed by a computer program or other mechanism that need not create an actual physical sample frame in performing this function.

In this embodiment, if each cookie is given an equal chance of selection from this sample frame then the probability of selection of any cookie is simply,

Probability of selection of each IPS cookie=1/number of cookies in the frame.

Designs that are more complex may create several independent frames, exclude certain elements from the frame, or intentionally use varying probabilities of selection to reduce the cost or improve the efficiency of designs.

At least two alternative frames are possible. One alternative frame is the set of Internet advertisements sent from the Internet advertising systems servers to the Web browser as the sampling units. The frame is formed by listing the Internet advertisements that are expected to be shown during the field period and cookies are selected into the sample by having a selected advertisement sent to their browser. The difficulty with this embodiment is that the probability of selection of any cookie is determined by the number of advertisements shown to the cookie, which leads to a high variability in the probability of selection. Another alternative sample frame, similar to the first, is a list of all of the page requests that IPS cookies are expected to submit to the Internet advertising system, where each page view or refresh, counts as a single sampling unit. Even though either of these two embodiments may allow for a probability survey to be completed more quickly, the preferred embodiment is to have the IPS cookies themselves be the sampling units of the frame because this leads to the least computational and mathematical complexity.

### Using the IP Address System to Restrict and Stratify the Sample Frame

The Internet has an IP address architecture whose current version is known as IPv4. The IP address is a number divided into 4 blocks of 8-bits, or one byte each. This means that each block can take one of 2⁸=256 values (0 to 255). An IP address is usually displayed as four 3-digit numbers,

0-255.0-255.0-255.0-255 for ex. 66.298.10.133

Every device that is accessible through the Internet is connected to the IPv4 framework.
It is inviting to think of this system as providing a frame from which computers may be sampled; however, this approach has many problems. IP addresses are not necessarily uniquely, or permanently assigned. One IP address may serve many computers on a private network, or one computer may have a different IP address assigned to it each time it signs on to the Internet. Furthermore, an IP address does not provide a way to contact the end user of a machine, which means that it cannot serve as a vehicle for a survey invitation.

However, the IP address system provides a method to detect a user's Internet Service Provider. Each country and ISP within those countries has been assigned ranges of IP addresses. Thus, it is entirely possible to restrict the IPS sample frame to the country or countries that the researcher is interested in sampling. This can be accomplished by restricting either the assignment of the IPS cookies or sampling of the IPS cookie to the range of IP addresses assigned to a given country by utilizing an “IF” command, a filter, or another mechanism that achieves this purpose. In the same way, it is also possible to restrict the IPS sample to household or residential computers.

In addition to using IP address ranges to restrict the sample, IP address ranges can be used to stratify the sample. The process of stratification divides the sample frame into two or more strata so that a more precise probability is obtainable within each stratum. The type of Internet connection can be easily determined for all Internet users from their IP Address. Thus, we can divide the sample frame by Internet connection type and conduct a separate probability sample for each Internet connection type. Furthermore, a specific location (city and state) of broadband Internet connections (DSL, Cable, T1, etc.) can be determined from the IP address allowing for geographic stratification within the broadband strata. It is well known to persons versed in survey research that stratification is a powerful tool with numerous applications in IPS sampling that need not be further explained here.

### Selecting IPS Cookies

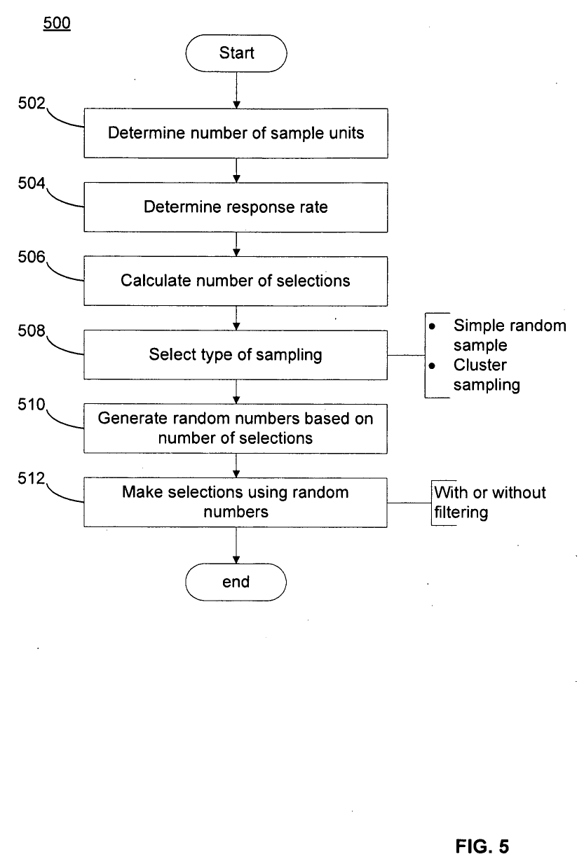

Referring to FIG. 5, the researcher normally determines the sample size of a survey, in step 502, where the sample can have any size up to the number of qualifying IPS cookies. Once the desired sample size “nₛ” is chosen, the following formula determines the number of advertisements that need to be displayed to obtain the sample size,

Number of selections=n/(response rate), in step 506,

where,

Response rate=(number of IPS cookies invited/number of completed responses) in step 504.

Previous studies conducted by the method can provide an estimate of the response rate. If no prior information is available, a best guess is used.

A method of sampling is selected in step 508. There are two major methods of selecting a sample from the sample frame: (i) systematic sampling, and (ii) simple random sampling.

### Systematic Sampling

Systematic sampling selects elements from a list at a chosen interval. After calculating the number of selections nₛ, this method of sampling calculates the sampling interval k as,

k=number of IPS cookies/number of selections

At the beginning of the field period, a computer generates, in step 510 of FIG. 5, a random start (i.e., a random integer selected with probability 1/k, where k is the fixed sampling interval) between 1 to k by computation or table lookup. The sampling method then selects the cookie whose position in the list is equal to the random number, in step 512. The process then samples every k^{th} unit by adding the fixed sampling interval k to the random start. Thus, if the random number is 5, the systematic selection chooses the 5^{th} advertisement, the (5+k)^{th} advertisement, the (5+2k)^{th} advertisement, and so on, until the calculated number of selections is reached. More formally, the selected sample s equals the set {m: m=r+(j−1)k≦N}, where N is the population size, r is the sample start, and j is an integer from 1 to nₛ, which is the sample size.

Many useful variations of systematic sampling exist. These include choosing multiple random starts, or multiple intervals, or subdividing the sampling frame in a way that benefits the researcher. Systematic sampling has the advantage of spreading the selections evenly over the frame, avoiding any bias that may result from clustering selections together in the frame. A disadvantage is that the sampling variance is not equal to the simple random sampling variance, which significantly complicates variance estimates.

### Simple Random Sampling

An alternative to systematic sampling is Simple Random Sampling. Simple Random Sampling first defines the total number of elements N that appear in the sample frame. In one embodiment, it selects a series of random numbers ε₁, ε₂, . . . , ε_{N}, indexed from 1 to the “number of elements in the frame”, where the number of random numbers selected is equal to the number of desired selections. Each of the random numbers is compared to a fixed constant between 0 and 1 to determine whether or not the element is selected. A computer program or a table can provide, in step 510, the random numbers.

Simple random sampling has the desirable statistical property that calculation of the variance is particularly easy. However, simple random sampling also has drawbacks in that it may be difficult to implement and has a number of undesirable realizations.

Once an IPS cookie is selected, it should remain selected. This means that the selected cookie continues to receive the invitation as an advertisement until one of the following happens: (i) the respondent completes the survey, (ii) the respondent is found to be ineligible, (iii) the survey field period ends, or (iv) the IPS cookie is deleted. A design that shows the survey invitation but then moves on to select a new respondent if the invitation is ignored is not a probability-based design, because the selection of units depends on the response probability of other selected units and this is immeasurable.

The IPS sample frame facilitates many different types of sample design. The frame can be easily stratified with the addition of variables to the database. Persons familiar with complex survey sample design realize that replicated designs are possible and may be preferred. Unlike APS, there is no additional cost to selecting geographically dispersed units. Unlike RDD samples, there is no risk of wasting resources on blank units. The IPS method holds out the possibility of a stratified simple random sample without the need for clustering. This type of design possesses simple mathematical properties and allows substantial reductions in sampling variance.

### Field Procedure

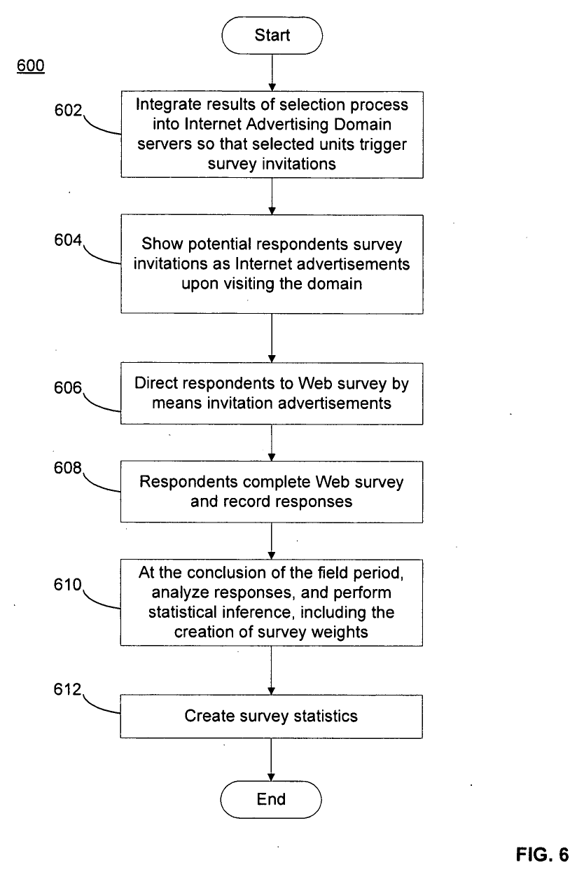

Referring to FIG. 6, in step 602, selected cookies are designated as such by a binary variable in the database or moved to another database within the Internet advertising system. The designation of “selected” simply triggers the display of the survey invitation by the Internet advertising system's to the selected cookies' host browsers while the survey is in field. During the field period, the server waits for the selected cookies to visit the domain. As shown in step 604, upon visiting the domain, the potential respondent receives an Internet advertisement on the page a survey invitation that might look like the following:
Who will you vote for?
Take a quick survey on the US presidential election.

The selected cookie continues to receive the invitation as an advertisement at every possible opportunity until one of the following happens: (i) the respondent completes the survey, (ii) the respondent is found to be ineligible, (iii) the survey field period ends, or (iv) the cookie is deleted. A design that shows the survey invitation but then moves on to select a new respondent if the invitation is ignored is not a probability-based design because the selection of units depends on the response probability of other selected units. The field period for the IPS sample should be long enough for a significant portion of the selected cookies to visit the domain and be invited to the survey. This may be days or weeks. Unlike face-to-face and telephone surveying, the surveyors have no way of initiating contact with potential survey respondents. A difficulty in setting the field period rests in the fact that it is impossible to know if an Internet cookie that has not visited the domain has been deleted or whether its CPU has just failed to visit the domain. Server traffic information may be able to help establish best practices for the appropriate duration of the IPS field period.

### Surveys

The IPS method is a tool that can empower any Internet survey or similar measurement tool used for any purpose. The only requirement is that the survey or other measurement tool collects the information required to properly weight the sample. The Internet advertisements are used, in one embodiment, to redirect users to a survey domain where a Web survey is administered and the survey responses are recorded, as shown in steps 606 and 608. To ensure the integrity of the sample, the domain should be secure and unpublished. The only way to access the survey should be through the invitations.

### Measuring the Probability of Selection

The number of Internet cookies representing a population member in the sample frame determines the probability of selecting that member of the population of interest.

Multiple Internet cookies representing a single population member can be created by using different Web browsers or user accounts on the same computer, or by using multiple computers. If the sample is restricted to residential IP addresses, the variability should be comparable to that of an RDD telephone sample. Each unit is weighted by the inverse of the number of Internet cookies from the domain. It should be easy to ascertain the proper weight by asking about computers used by the individual or computers in the household.

Relationship between Population and the IPS Sample Frame

The relationship between the cookie in the sample frame and the respondent is shown in FIG. 1B. For example, a respondent that completes the Web survey, in step 608, says he has two computers 150, 152 in FIG. 1B in the household. He responds that each computer 150, 152 primarily uses one user account 154 and Web browser 156 to visit the hosting domain. This indicates that the household has two Internet cookies that could enter the sample. The observation is assigned a probability weight of ½.

In addition to the probability weight, additional weights can be added to adjust the sample to demographic norms, or compensate for non-response. A weight is developed for each member of the population of interest in the sample, as shown in 610.

### Estimation

To calculate population parameters, the weights are multiplied to form a composite weight that is associated with each observation in the sample. We then use the formula for computing weighted mean,

y̅_{w}=(Σyᵢwᵢ)/(Σwᵢ)

where y is the survey value and w is the weight. If the design is a stratified random sample, the variance of the result can be calculated using the Taylor series approximation of the variance of weighted samples,

Var( y̅_{w})=[1/(Σwᵢ)²]×[n(s_{wy}²)+ y̅_{w}²n(s_{w}²)−2 y̅_{w}nCov(wy,w)]

where Cov(wy,w)=(1/n−1)(Σ[wᵢyᵢ−E(wy)][wᵢ−E(w)]). These formulas are used to calculate the survey statistics, in step 612. If a more complex sample design is used, the variance of the weighted mean is a function of the sample design that can be estimated using Taylor series or replicated methods. A complex sample estimation software package, such as SAS, SUDAAN, or CENVAR, should be used to calculate the variance estimates. However, the correct design-adjusted variance of IPS method samples can be calculated without resorting to the incorrect application of simplified variance formulas.

### Example of an IPS

This section provides a hypothetical example of the IPS method. This example shows how an IPS could work, but should not be interpreted as the only or absolute best realization of the IPS method. In order to describe a working example of the Internet Probability Sample, the example makes many assumptions. The Internet advertising domain is treated as if it were a single server, which in practice will not be the case. Boolean logic is used in the server commands where efficient code in a server language is necessary. The example also makes a convenience out of the data cited in examples, whereas real world phenomena are far more complex.

First, we must define the goal of the project. Our goal is to measure the percentage of Internet users in the United States who are in favor of Net Neutrality legislation. Note that this goal defines our target population as “Internet Users in the United States.”

### Example Sample Frame

To conduct the IPS, we assume that we have partnered with a large Internet advertising system domain. To construct the sample frame, the system places an IPS Internet cookie with all recent visitors who have a unique identifier and captures the last IP address and time of the most visit of the IPS cookie. We pull all of the cookies that were recently active into a single database that forms our sample frame. We filter the command so that only US cookies are included. In the example database, Internet cookies with IP addresses that originate in the United States and have been active in the last 30 days (720 hours) are assigned the variable FRAME_ELEMENT=1 and are drawn into the sample frame database.

### Example Internet Cookie Database

| Unique_ID | IP Address | Country | HOURS_LTIME | FRAME_ELEMENT |
|---|---|---|---|---|
| 000000001 | 129.42.208.24 | United States | 25 | 1 |
| 000000002 | 139.18.184.55 | Germany | 16 | — |
| 000000003 | 168.213.1.131 | United States | 160 | 1 |
| 000000004 | 203.162.2.14 | Vietnam | 46 | — |
| 000000005 | 208.100.231.5 | United States | 643 | 1 |
| 000000006 | 208.76.82.97 | United States | 2 | 1 |
| 000000007 | 220.181.32.214 | China | 71 | — |
| 000000008 | 38.112.113.65 | United States | 842 | — |
| 000000009 | 58.136.16.115 | Thailand | 25 | — |
| 000000010 | 66.249.67.164 | United States | 16 | 1 |

Additionally, the sample frame can be extended to include the Internet cookies that are expected to be created during the survey field period. This should be relatively easy so long as new Internet cookies are assigned in a systematic fashion. First, we estimate the number of cookies that will be created in the US during the field period by examining the number of cookie created during a similar period. We then construct hypothetical entries for these cookies in the sample frame. These units provide coverage for first time visitors to the domain and users that have deleted their cookies.

In the example below, we collect the 100 million Internet cookies in a database and create a hypothetical 1 million additional entries for new cookies in the database.

### Example IPS Sample Frame

| Unique_ID | IP Address | Country | HOURS_LTIME |
|---|---|---|---|
| 000000001 | 129.42.208.24 | United States | 25 |
| 000000003 | 168.213.1.131 | United States | 160 |
| 000000005 | 208.100.231.5 | United States | 643 |
| 000000006 | 208.76.82.97 | United States | 2 |
| 000000010 | 64.12.112.100 | United States | 16 |
| . . . | . . . | United States | >720 |
| 234567890 | — | United States | 0 |
| . . . | — | United States | 0 |
| 235567891 | — | United States | 0 |

### Stratification

The architecture of the IP address system dictates our method of stratification. The type of Internet connection can be easily determined for all Internet users from their IP addresses. The geographic location of users is more complex. The location of broadband Internet connections (DSL, Cable, T1, etc.) can be determined from the IP address, while dial-up Internet services use only a handful of IP addresses to serve all of their customers, making it impossible to geographically locate these Internet users.

To best make use of the system, we first stratify the sample by Internet connection type by placing dial-up Internet users in a first stratum (STRATUM=1) and broadband Internet users in a second stratum (STRATUM=2 OR 3). In the broadband stratum, we use the geographic location of the IP address to subdivide further the sample; however, these divisions are only placeholders for post-stratification. Each response, regardless of Internet connection type is placed in geographic strata after data collection.

In order to geographically stratify the broadband Internet cookies, we match merge the IP addresses in the database with an IP-geography database, several free and pay versions of which are available on the Internet.¹ We match the last known IP address of each Internet cookie with the counties of the United States by FIPS code. In practice, an IPS sample design can use many geographic strata within the broadband stratum to ensure accurate representation of all geographical regions of the US. In this example, we classify the broadband IP addresses into two strata: metropolitan broadband, non-metropolitan broadband. Broadband IP addresses associated with counties that are a part of the 20 largest Metropolitan Statistical Areas² (MSA) are placed into the metropolitan stratum (STRATUM=2). Other IP addresses with known origin that is not in one of the 20 largest MSAs are placed in the non-metropolitan strata (STRATUM=3).

The hypothetical cookies pose a special problem because it is impossible to know which stratum they belong to until they are created. If possible, in the advertising domain the assignment of UNIQUE_IDS can be based on the stratum to which they belong. In any case, hypothetical Internet cookies are appended to every stratum in the sample.

The physical process of stratification is achieved by sorting the entries in the sample frame or creating separate databases for each stratum. The stratified sample design selects a controlled proportion of Internet cookies from within each stratum.

### Example Stratified IPS Sample Frame

| UNIQUE_ID | IP ADDRESS | CITY | STATE | FIPS | CONNECT | STRATUM |
|---|---|---|---|---|---|---|
| 000000010 | 64.12.112.100 | . | . | . | DIAL-UP | 1 |
| 000000032 | 64.12.112.100 | . | . | . | DIAL-UP | 1 |
| . . . | . . . | . | . | . . . | . . . | 1 |
| 000000001 | 129.42.208.24 | SOMERS | NY | 36119 | DSL | 2 |
| 000000003 | 168.213.1.131 | ST. | FL | 12103 | T1 | 2 |
| | | PETERSBURG | | | | |
| 000000006 | 208.76.82.97 | LAKE ORION | MI | 26125 | CBL-MOD | 2 |
| . . . | . . . | . . . | . . . | . . . | . . . | 2 |
| 000000005 | 208.100.231.5 | GREENVILLE | AL | 01013 | CBL-MOD | 3 |
| 000123456 | 72.224.75.43 | CLIFTON | NY | 36091 | DSL | 3 |
| | | PARK | | | | |
| . . . | . . . | . . . | . . . | . . . | . . . | 3 |

1 See http://www.find-ip-address.org/
2 Metropolitan Statistical Areas are defined by the U.S. Office of Management and Budget. See http://www.census.gov/population/www/cen2000/briefs/phc-t29/index.html

### Example—Selecting Units

The first step in selecting the sample is to determine the number of units to select. For simplicity, let us say that we desire to have a survey of 10 completed responses. We plan our selections with the goal of allocating the responses to each stratum according to its proportion in the population. The distribution of the total elements across the strata in the sample frame provides a good estimate of the strata sizes in the population.

| | No. of | | |
|---|---|---|---|
| Stratum | Internet Cookies | % of Total | Desired |
| Dial-up | 17.2 million | 17.2% | 2 |
| Broadband Large MSA - 2 | 61.7 million | 61.7% | 6 |
| Broadband Non-Large MSA - 2 | 21.1 million | 21.1% | 2 |
| Total | 100 million | 100% | 10 |

There is a large amount of flexibility in the design at this point. The number of selections in the individual stratum can be adjusted to fit the overall goals of the research. For example, a design may allocate a greater than proportional share of its selection to the stratum of Internet cookies with dial-up connections in order to have a higher probability of selecting dial-up users in many geographic strata.

To determine the number of selections in each stratum, we estimate the contact rate, which is the proportion of units that actually visit the domain during the field period and receive the survey invitation and the response rate, which is the proportion of the Internet cookies that complete the survey out of those that receive the invitation. Over time, we can estimate these rates precisely using past surveys. For now, let us say that we estimate the rates as follows:

| Stratum | Contact Rate | Response Rate | Desired | Selections |
|---|---|---|---|---|
| Dial-up | 50% | 15% | 2 | 27 |
| Broadband Large | 90% | 20% | 6 | 33 |
| MSA - 2 | | | | |
| Broadband Non- | 80% | 25% | 2 | 10 |
| Large MSA - 2 | | | | |

In each stratum, we determine the number of selections by the following formula,

Number of selections=(Desired number of completes/[Contact Rate×Response Rate].

We perform a simple random sample in each stratum. It is easiest to perform this procedure by appending a new variable that uniquely numbers each frame element within each stratum. We call this variable ELEMENT_NUM. In the Large MSA stratum, ELEMENT_NUM assigns numbers from 1 to 60,000,000 to these cookies. We generate 33 random numbers from 000001 to 60,000,000. The numbers are generated by a computer or chosen from a table of random numbers. If one of those numbers is 00000004, the Internet cookie with ELEMENT_NUM=4 is selected.

| | | | | SE- |
|---|---|---|---|---|
| | | | | LECT- |
| Unique_ID | IP Address | STRAUM | ELEMENT_NUM | ED |
| 000000001 | 129.42.208.24 | 1 | 000000001 | 0 |
| 000000003 | 168.213.1.131 | 1 | 000000002 | 0 |
| 000000006 | 208.76.82.97 | 1 | 000000003 | 0 |
| 000000010 | 203.162.2.14 | 1 | 000000004 | 1 |
| 000001489 | 208.100.231.5 | 1 | 000000005 | 0 |
| 000556790 | 208.76.82.97 | 1 | 000000006 | 0 |
| 003542170 | 220.181.32.214 | 1 | 000000007 | 0 |
| . . . | . . . | 1 | . . . | — |
| 100000000 | 58.136.16.115 | 1 | 060000000 | 0 |

We perform this process in the two other strata. This is only one of many ways in which the sample can be selected. Simple random sampling is preferred here because it conceptually and computationally easy. The IPS enables this intuitive design by circumventing travel and investigative costs that prevent its use in other probability-based sampling methods.

### Field Procedure

A binary variable identifies selected elements, which are imported into the survey database. This database tracks the progress of the survey during the field period.

### The Survey Database

| UNIQUE_ID | IMPRESSIONS | CLICKS | COST | STATUS |
|---|---|---|---|---|
| 0123456789 | 0 | 0 | 0 | 0 |

Each row in the database is a selected Internet cookie, identified by its unique ID. The IMPRESSIONS field counts the number of invitations displayed to the cookie. The CLICKS field tracks the number of times the survey invitation is clicked. The COST variable tracks the cost associated with that unit. STATUS tracks the progress of the respondent with respect to the survey, such as “Not Started=0”, “Complete=1”, “Partial=2”, etc.

At this point, let us assume that our Web survey is complete and published in a secure domain, only accessible through the survey invitations. Now we are ready to put our survey into field. The process of beginning the field period is no more than enabling code that displays the survey invitation to selected cookies when those cookies are submitted to the domain. Potential respondents receive as an Internet advertisement on the page a survey invitation that might look like this:
Share your opinion
Take a quick survey on Internet policy legislation

Our design places a limit of no cost ($0.00) to display the ad and $0.50 per click on the placement of the survey invitation. As long as these conditions are met, the selected cookie continues to receive the survey every time a page request is submitted to the domain.

The survey that we have fielded is short and direct; it does not include repetitive questions and long matrices, which helps to decrease the drop off rate. If a respondent does drop off, his status is recorded as partial in the survey database and his progress is saved so that he can pick-up where he left off. The survey includes these questions to correctly weight the survey:
Do you log on and off this computer when you start using it? If yes, how many different user accounts do you use to browse the Internet?
Do you typically use any other Web browsers (ex. Internet Explorer, Firefox) on this computer besides the one that you are using right now?→If yes, how many?
Do you typically use any other computers to browse the Internet?→If yes, how many? How many user accounts? How many browsers? For Work or at Home?

The field period continues for a reasonable amount of time so that most of the selections are contacted. Suppose that, after seven days in field, 90% of the selected cookies are contacted and we have obtained 10 complete responses. This is a good time to end the field period. We end the process of displaying survey invitations and extract the dataset for analysis.

### Weighting and Estimation

So that the statistics we publish reflect the entire Internet population, we weight the results using the following formula,

Weight₁=1/(# of respondent Internet cookies)

where the number of Internet cookies is counted from the number of computer, user account, and Web browser combinations reported by the respondent. We save this probability weight as a new variable in the dataset called W1 and apply it to the data set.

| | Estimated Frame | |
|---|---|---|
| UNIQUE_ID | Elements | Probability Weight (w₁) |
| 0123456789 | 1 | 1 |
| Respondent 2 | 2 | 0.5 |
| Respondent 3 | 1 | 1 |
| Respondent 4 | 1 | 1 |
| Respondent 5 | 4 | 0.25 |
| Respondent 6 | 2 | 0.5 |
| Respondent 7 | 3 | 0.333 |
| Respondent 8 | 2 | 0.5 |
| Respondent 9 | 3 | 0.333 |
| Respondent 10 | 1 | 1 |

At this point, we are prepared to form an estimate percentage of US Internet users that support Net Neutrality legislation. Let us suppose that we have collected the following results.

| | Probability | | Support NN (y) | |
|---|---|---|---|---|
| UNIQUE_ID | Weight (w₁) | Stratum | (1 = Yes) (0 = No) | w₁ * y |
| Respondent 2 | .5 | 1 | 1 | 0.5 |
| Respondent 3 | 1 | 1 | 1 | 1 |
| Respondent 4 | 1 | 1 | 1 | 1 |
| Respondent 6 | .5 | 1 | 0 | 0 |
| Respondent 7 | .333 | 1 | 1 | 0.333 |
| Respondent 8 | .5 | 1 | 1 | 0.5 |
| Respondent 10 | .333 | 1 | 1 | 0.333 |
| 0123456789 | 1 | 2 | 1 | 1 |
| Respondent 5 | .25 | 2 | 1 | 0.25 |
| Respondent 9 | 1 | 2 | 0 | 0 |
| Total (Σ) | 6.416 | | 8 | 4.916 |
| s² | .102 | | | 0.152 |

For the moment, ignoring the stratum variable, we can easily calculate the weighted estimate of support as y̅w=(Σyᵢwᵢ)/(Σwᵢ)=4.916/6.416=76.6%. The variance of this estimate is calculated, using the Taylor series approximation for weighted means,

Var( y̅_{w})=[1/(Σwᵢ)²]×[n(s_{wy}²)+ y̅_{w}²n(s_{w}²)−2 y̅_{w}nCov(wy,w)]

where Cov(wy,w)=(1/n)(E[wᵢyᵢ−E(wy)][wᵢ−E(w)]). The resulting calculation is,

Var( y̅_{w})=[1/(6.416)²]×[10(0.151)+0.766²10(0.102)−2(0.766)(10)(0.063)]

Var( y̅_{w})=0.0279

The standard deviation of the estimate is the square root of the variance and is 0.167. However, we can improve upon this estimate by utilizing the stratification in our sample design and some outside information. In the survey, we have asked for the ZIP code of the respondents and have located them as residing inside or outside of the 20 largest MSAs. From the US Census Bureau's Current Population Survey, we obtain an independent estimate of the percentage of the Internet population residing inside and outside of the 20 Large MSAs. To improve our estimate, we form estimates for each of the strata separately and then combine them to calculate our population estimates.

### Post-Stratification

| | Stratum Size | Support Net | Stratum |
|---|---|---|---|
| Stratum | Proportion | Neutrality % | Variance |
| Large MSA - 1 | 81.2% | 87.9% | .025 |
| Non-Large MSA - 2 | 18.7% | 55.5% | .167 |

From this data, we can calculate the stratum means and variances and use these to derive the population estimates. The population mean is the weighted average of the stratum means,

(ΣWₕ y̅ₕ)=0.812×0.879+0.187×0.555=0.819

The population variance can then be calculated using the formula,

Var y̅ₕ=ΣWₕ²var( y̅ₕ)=(0.812)²(0.025)+(0.184)²(0.167)=0.0222

The standard deviation of this sample is 0.149. Notice that the post-stratification has reduced the variance of the estimate from 0.0279 to 0.0222. This is just one of many techniques that can be employed to enhance the precision of an IPS. In the common method of reporting statistics, the results are read as 81.9% of the Internet population supports the Net Neutrality legislation with a margin of error of 29%. Even though this small sample size tells us little about the support for the Net Neutrality legislation, it demonstrates the effectiveness and flexibility of the IPS method for estimating population values.

Although the present invention has been described in considerable detail with reference to certain preferred versions thereof, other versions are possible. Therefore, the spirit and scope of the appended claims should not be limited to the description of the preferred versions contained herein.

What is claimed is:

1. A method of performing an on-line survey of a target population, the method comprising:
constructing a sample frame based on the interactions of a plurality of browsers with an Internet domain, said sample frame including one or more databases of a number of IPS cookies, wherein each IPS cookie is a selectable unit in the frame;
performing a randomized selection process on the sample frame to create a sample of selected units from the sample frame, wherein each unit has a known and non-zero probability of inclusion in any sample taken from the sample frame, and each selected unit is a candidate for the on-line survey, and wherein the sample has a number of selected units that fit a response criteria;
sending one or more invitations to complete the on-line survey to the selected candidates;
receiving a completed survey from a number of responding candidates(respondents), the number of respondents being less than or equal to the number of selected candidates;
computing a probability of selection of each respondent;
constructing survey weights based on the selection probability of each respondent; and
calculating one or more survey statistics using the data from the respondents and the survey weights.

2. The method of performing an on-line survey, as recited in claim 1, wherein performing the randomized selection process includes performing a systematic sampling of units in the frame.

3. The method of performing an on-line survey, as recited in claim 1, wherein performing the randomized selection process includes performing a simple random sampling of units in the frame.

4. The method of performing an on-line survey, as recited in claim 1, wherein the sample frame includes IPS cookies that meet certain criteria defined by a researcher using the method.

5. The method of performing an on-line survey, as recited in claim 1, wherein the sample frame includes IPS cookies that are expected to be created during a sample period.

6. The method of performing an on-line survey, as recited in claim 1, wherein each IPS cookie has a unique ID.

7. The method of performing an on-line survey, as recited in claim 1, wherein the probability of selection is equal to the reciprocal of the number of cookies in the sample frame.

8. The method of performing an on-line survey, as recited in claim 1, further comprising the step of filtering the sample frame to exclude certain elements from the frame.

9. The method of performing an on-line survey, as recited in claim 8, wherein the step of filtering the sample frame includes filtering the sample frame based on IP address ranges.

10. The method of performing an on-line survey, as recited in claim 8, wherein the step of filtering the sample frame includes filtering the sample frame to include only household or residential computers.

11. The method of performing an on-line survey, as recited in claim 1, wherein the step of computing the probability of selection includes varying the probability of selection of a cookie to exclude certain units from the sample.

12. The method of performing an on-line survey, as recited in claim 1, wherein constructing the survey weights includes normalizing the weights so that the sum of the weights is unity.

13. The method of performing an on-line survey, as recited in claim 1, further comprising maintaining a database of survey information, after sending the on-line survey to the selected candidates.

14. The method of performing an on-line survey, as recited in claim 13, wherein the survey database keeps track of the number of survey invitations sent to a survey candidate.

15. The method of performing an on-line survey, as recited in claim 1, wherein the step of sending one or more survey invitations includes sending a survey invitation as an Internet advertisement.

16. The method of performing an on-line survey, as recited in claim 1, wherein the completed survey includes information about a relationship between the respondent and the selected IPS cookie corresponding to the respondent.

17. The method of performing an on-line survey, as recited in claim 1,
wherein each respondent in the sample is associated with one or more IPS cookies; and
wherein the step of constructing survey weights includes computing the weights as a reciprocal of the number of respondent Internet cookies.

18. The method of performing an on-line survey, as recited in claim 17,
wherein the completed survey includes the number of computer, user accounts, and Web browser combinations; and
wherein the number of respondent IPS cookies is determined from the number of computer, user accounts, and Web browser combinations.
